(19) United States
(12) Patent Application Publication
(10) Pub. No.: US 2011/0294492 A1
(43) Pub. Date: Dec. 1, 2011

(54) FEMTOCELL, COMMUNICATION METHOD FOR THE FEMTOCELL, AND COMPUTER READABLE MEDIUM THEREOF

(75) Inventors: Heng-Iang HSU, Taipei City (TW); Hsien-Tsung HSU, Taipei City (TW); Jean-Chian CHIOU, Yonghe City (TW); I-Hung LIN, Taipei City (TW)

(73) Assignee: INSTITUTE FOR INFORMATION INDUSTRY, Taipei (TW)

(21) Appl. No.: 12/859,458

(22) Filed: Aug. 19, 2010

(30) Foreign Application Priority Data
May 31, 2010 (TW) 099117392

(51) Int. Cl. H04W 40/00

(52) U.S. Cl. 455/422.1

(57) ABSTRACT

A femtocell, a communication method for the femtocell, and a computer program product thereof are provided. A network system comprises the femtocell, a base station, and a femto gateway. The base station connects to an Internet via the femto gateway, and the femtocell initially connects to the Internet via a backhaul network. After the femtocell detects the backhaul network being in a disconnection status, it switches to a user equipment (UE) mode. Then, the femtocell uses the UE mode to build a connection with the base station so that the femtocell is able to connect to the Internet via the base station and the femto gateway.

### PRIORITY

This application claims priority to Taiwan Patent Application No. 099117392, filed on May 31, 2010, which is hereby incorporated by reference.

### FIELD

The present invention relates to a femtocell, a communication method for the femtocell, and a computer readable medium thereof. More particularly, the femtocell, the communication method for the femtocell, and the computer readable medium thereof of the present invention are able to provide a backup network when a backhaul network fails so that the femtocell can still connect to the Internet.

### BACKGROUND

Owing to advancement of science and technology, wireless network technologies have now become a hot topic of research in the art. Accordingly, many wireless network technologies, e.g., the worldwide interoperability for microwave access (WiMAX) and the 3^{rd}-generation (3G) mobile communication technologies, are developing towards the stage of commercialized application, which results in coexistence of the two technologies (i.e., WiMAX and 3G) in the market and also announces advent of the wireless broadband era in Taiwan. However, the operators, no matter the WiMAX operators or the 3 G operators, are all confronted with a problem of insufficient coverage in indoor environment because signals of a base station (BS) tend to be attenuated when arriving in the indoor environment due to a long transmission distance or due to blocking by the walls. In order to reinforce the insufficient communication coverage, the femtocell technology has been introduced by many operators.

Generally speaking, a femtocell has a coverage area smaller than that of a base station, and is mainly used to cover an area that can not be covered by the base station in order to reduce dead zones and improve the data rate. A conventional femtocell utilizes a licensed wireless band for the front-end network thereof, so no modification has to be made on the user equipment; on the other hand, the backhaul network of the conventional femtocell may be a wired network, for example, a digital subscriber line (DSL) modem or a cable modem. The conventional femtocell connects to the Internet via the backhaul network so that the user equipment can connect to the Internet via the femtocell.

The backhaul network might be in a disconnection status for some reasons (e.g., due to failure of the network or due to an excessively high volume of data traffic). In this case, the femtocell will fail to connect to the Internet, making it impossible for the user equipment to connect to the Internet via the femtocell. Unfortunately, no solution to this has been provided. In view of this, there remains a need to provide a solution that can avoid failure of the user equipment to connect to the Internet due to disconnection of the backhaul network.

### SUMMARY

An objective of certain embodiments of the present invention is to provide a femtocell. A network system comprises the femtocell, a base station, and a femto gateway. The base station connects to the Internet via the femto gateway, and the femtocell initially connects to the Internet via a backhaul network. The femtocell comprises a detection unit, a switch unit and a transceiver. The detection unit is configured to detect that the backhaul network is in a disconnection status. The switch unit is configured to switch the femtocell to a user equipment (UE) mode after the detection unit detects that the backhaul network is in the disconnection status. The transceiver is configured to build a connection with the base station by the UE mode so that the femtocell is able to connect to the Internet via the base station and the femto gateway.

Another objective of certain embodiments of the present invention is to provide a communication method for a femtocell. The network system comprises the femtocell, a base station, and a femto gateway. The base station connects to the Internet via the femto gateway, and the femtocell initially connects to the Internet via a backhaul network. The communication method comprises the following steps of: (a) enabling the femtocell to detect that the backhaul network is in a disconnection status; (b) enabling the femtocell to switch to a UE mode after the femtocell detects the disconnection status; and (c) enabling the femtocell to build a connection with the base station by the UE mode so that the femtocell is able to connect to the Internet via the base station and the femto gateway.

Furthermore, to achieve the aforesaid objectives, certain embodiments of the present invention further provide a computer readable medium, which stores a computer program. When the computer program is loaded into a femtocell, a plurality of codes thereof can be executed to accomplish the communication method described above.

When a disconnection status of the backhaul network is detected, the femtocell can switch to the UE mode and try to connect to the base station by the UE mode. If the femtocell builds a connection with the base station successfully, then the role of the original backhaul network will be replaced by this new connection. In other words, the femtocell will continue to connect to the Internet via the base station and the femto gateway instead. With the present invention, even when the backhaul network is disconnected, the femtocell can still connect the user equipment to the Internet.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A is a schematic view of a network system according to an e embodiment of the present invention;

FIG. 1B is a schematic view illustrating an architecture of the femtocell as well as signal transmissions between the femtocell, the base station and the femto gateway according to an example embodiment of the present invention;

FIG. 1C is a schematic view illustrating signal transmissions when the network system conforms to the LTE standard; and

FIG. 2 is a flowchart of a communication method of an example embodiment of the present invention.

### DETAILED DESCRIPTION

Descriptions of the following example embodiments are only intended to illustrate but not to limit the present invention. It should be appreciated that, in the following example embodiments and the attached drawings, elements unrelated to the present invention are omitted from depiction; and dimensional relationships among individual elements in the attached drawings are illustrated only for ease of understanding, but not to limit the actual scale.

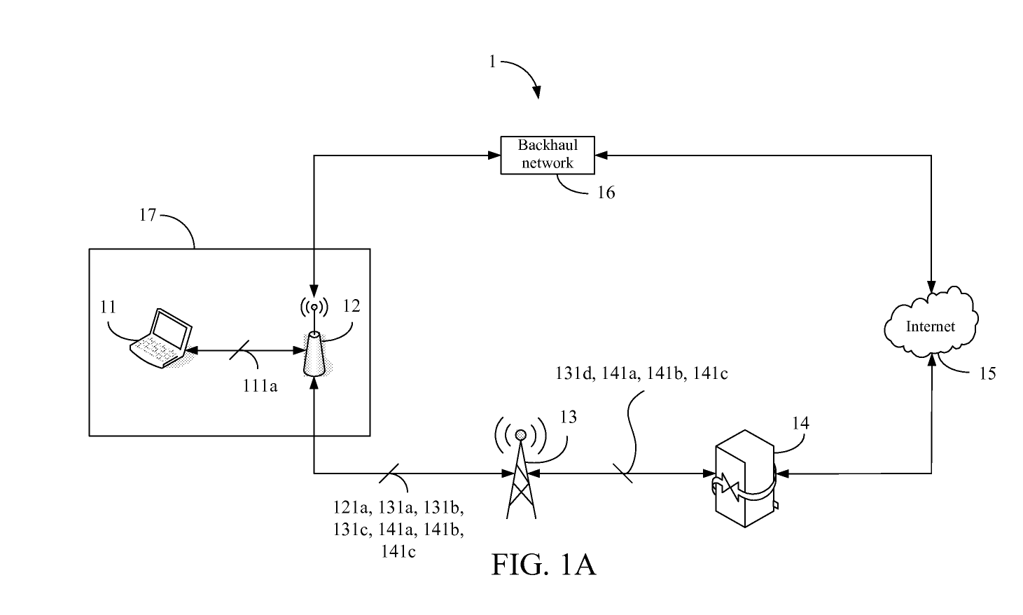

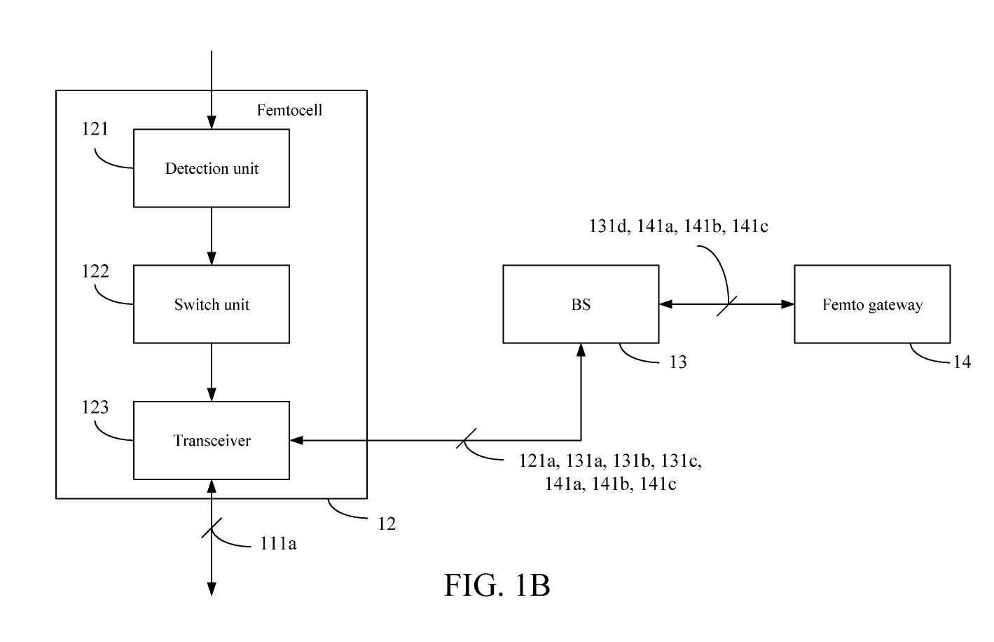

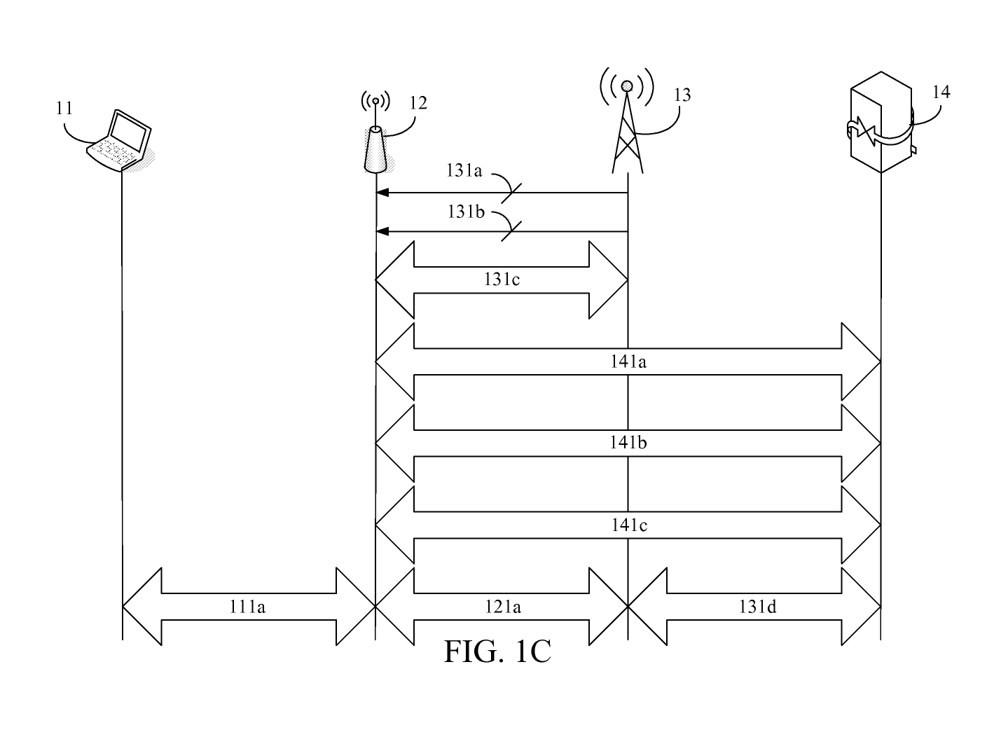

A first embodiment is a network system 1, an architecture of which is shown in FIG. 1A. The network system 1 comprises a user equipment 11, a femtocell 12, a base station 13, and a femto gateway 14. In this embodiment, the user equipment 11 may be a mobile apparatus such as a notebook computer or a mobile phone, and the femtocell 12 is located inside a building 17 (e.g., a house). The base station 13 connects to the Internet 15 via the femto gateway 14. The femtocell 12 initially connects to the Internet 15 via a backhaul network 16, which may be a wired broadband network (e.g., a digital subscriber line (DSL) modem or a cable modem). When the user equipment 11 is located inside the building 17, the user equipment 11 connects to the Internet 15 via the femtocell 12.

For some reasons (e.g., due to failure of the network or due to an excessively high volume of data traffic), the backhaul network 16 might turn from a connection status into a disconnection status. If the backhaul network 16 is in a disconnection status, the femtocell 12 will fail to connect to the Internet 15 continuously, making it impossible for the user equipment 11 to connect to the Internet 15 via the femtocell 12 any longer. To solve this problem, provisions are made in the femtocell 12 for allowing the user equipment 11 to connect to the Internet 15 continuously via the femtocell 12, which will be detailed hereinafter.

Referring to FIG. 1B, a schematic view illustrating an architecture of the femtocell 12 as well as signal transmissions between the femtocell 12, the base station 13, and the femto gateway 14 is shown therein. The femtocell 12 comprises a detection unit 121, a switch unit 122, and a transceiver 123. In this embodiment, the detection unit 121 and the switch unit 122 may be any of various microprocessors, central processing units (CPUs) or devices with computing capabilities that will readily occur to those of ordinary skill in the art, available either at present or in the future. The transceiver 123 in this embodiment may be any of various transceiving interfaces available either at present or in the future.

In case the backhaul network 16 fails (i.e., is disconnected), the detection unit 121 of the femtocell 12 will detect that the backhaul network 16 is in a disconnection status. After the disconnection status is detected by the detection unit 121, the switch unit 121 switches to a user equipment (UE) mode. It shall be appreciated that, the “UE mode” as described in the present invention means that the femtocell 12 is able to connect to the base station 13 as an UE's behavior (e.g., is able to forward/transmit data and has the same communication protocol as the user equipment). After the femtocell 12 is switched to the UE mode, the transceiver 123 of the femtocell 12 builds a connection with the base station 13 by the UE mode. Thus, the femtocell 12 can connect to the Internet 15 via the BS 13 and the femto gateway 14.

The network system 1 of the first embodiment is not limited to any specific network system. For example, the network system 1 may conform to the worldwide interoperability for microwave access (WiMAX) standard, the Long Term Evolution (LTE) standard, or the 3^{rd}-generation (3G) standard.

Hereinafter, details of how the transceiver 123 of the femtocell 12 builds the connection with the BS 13 by the UE mode will be further described with reference to the LTE standard. Referring also to FIG. 1C, a schematic view illustrating signal transmissions when the network system 1 conforms to the LTE standard is shown therein.

To achieve synchronization and build proper connections between the femtocell 12, the base station 13, the femto gateway 14, and the Internet 15, the transceiver 123 of the femtocell 12 receives a synchronization signal 131a and a piece of basic information 131b from the base station 13. In the LTE standard, the synchronization signal 131a is a primary synchronization signal (PSS) and a secondary synchronization signal (SSS), and the basic information 131b comprises a master information block (MIB) and at least one system information block (SIB). The MIB and the SIB carry at least a piece of system information (SI).

Next, the transceiver 123 of the femtocell 12 performs a setup procedure with the base station 13. In the LTE standard, the setup procedure 131c is a radio resource control (RRC) connection setup procedure. Additionally, to ensure security of the information transmission, the transceiver 123 may perform a security certification procedure 141a and a data stream building procedure 141b with the femto gateway 14 via the base station 13. Through the data stream building procedure, a data stream is built. In the LTE standard, the security certification procedure 141a is a non-access stratum security (NAS security) certification procedure, and the data stream 141b is an evolved packet system (EPS) bearer service setup procedure.

Furthermore, after the femtocell 12 builds the connection with the base station 13, the transceiver 123 of the femtocell 12 may further transmit a disconnection notification message 141c to the femto gateway 14 to notify the operator of the femtocell 12 to repair the backhaul network. For example, if the femtocell 12 has been assigned an Internet Protocol (IP) address when initially connecting to the Internet 15 via the backhaul network 16, the disconnection notification message 141c may comprise the IP address so that the operator of the backhaul network 16 can find the backhaul network 16 corresponding to the femtocell 12 according to this IP address.

Through the aforesaid operations of the femtocell 12 in the UE mode, a connection is built between the femtocell 12 and the base station 13, and the femtocell 12 can connect to the Internet 15 via the base station 13 and the femto gateway 14. Then, data service transfers 111a, 121a, 131d are carried out between the user equipment 11, the femtocell 12, the base station 13 and the femto gateway 14 via the data stream built as described above.

The data service transfer 111a between the user equipment 11 and the femtocell 12 adopts an encryption method agreed by both the user equipment 11 and the femtocell 12; the data service transfer 121a between the femtocell 12 and the base station 13 adopts an encryption method agreed by both the femtocell 12 and the base station 13; and the data service transfer 131d between the base station 13 and the femtocell 14 adopts an encapsulating encryption method over the IP layer. Thus, enough security can be obtained for data transmissions between the user equipment 11 and the femto gateway 14 so that connection of the user equipment 11 to a femtocell 12 that has not been authenticated to be secured is avoided.

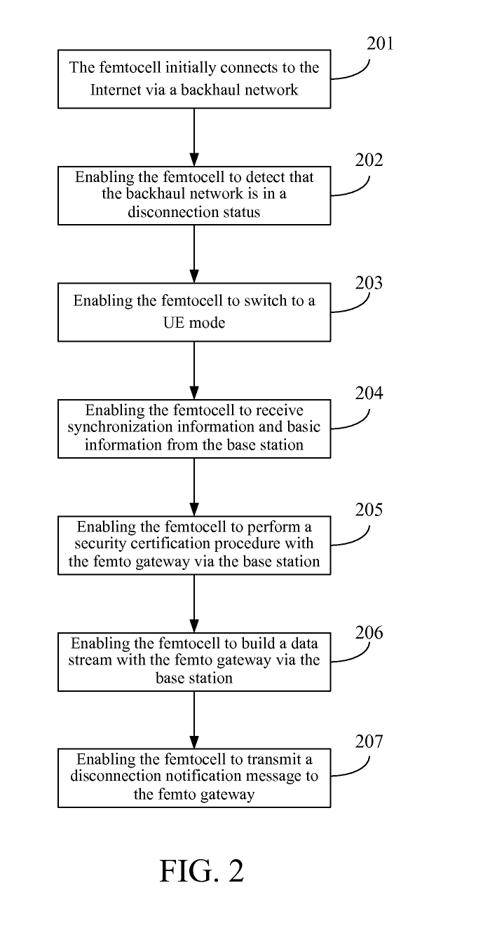

A second embodiment is a communication method for a femtocell, a flowchart of which is shown in FIG. 2. A network system comprises the femtocell, a base station and a femto gateway, an example of which is the network 1, the femtocell 12, the base station 13 and the femtocell 14 of the first embodiment. The base station connects to the Internet via the femto gateway.

Firstly, in step 201, the femtocell initially connects to the Internet via a backhaul network. Then, step 202 is executed to enable the femtocell to detect that the backhaul network is in a disconnection status. After the disconnection status is detected by the femtocell, step 203 is executed to enable the femtocell to switch to a UE mode. Then, the communication method of the second embodiment proceeds to build a connection with the base station by the UE mode. Specifically, in the second embodiment, steps 204, 205 and 206 are executed to enable the femtocell to build the connection with the base station by the UE mode.

In more detail, step 204 is executed to enable the femtocell to receive a piece of synchronization information and a piece of basic information from the base station. Then, step 205 is executed to enable the femtocell to perform a security certification procedure with the femto gateway via the base station, and step 206 is executed to enable the femtocell to build a data stream with the femto gateway via the base station. Finally, step 207 is executed to enable the femtocell to, after building the connection with the base station, transmit a disconnection notification message to the femto gateway to notify the operator of the backhaul network that a first-aid repair must be made.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

The communication method of the second embodiment may be implemented by a computer program. When the computer program is loaded into the femtocell, a plurality of program codes of the computer program will be executed to accomplish the communication method of the second embodiment. This computer program may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

According to the above descriptions, when a disconnection status of the backhaul network is detected, the femtocell of the present invention can switch to the UE mode and try to connect to the base station by the UE mode. If the femtocell builds the connection with the base station successfully, then the role of the original backhaul network will be replaced by this new connection so that user equipment can continue to connect to the Internet via the femto gateway instead. With the present invention, even when the backhaul network is disconnected, the femtocell can still connect the user equipment to the Internet.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication method for a femtocell, a network system comprising the femtocell, a base station, and a femto gateway, the base station connecting to the Internet via the femto gateway, the femtocell initially connecting to the Internet via a backhaul network, and the communication method comprising the steps of:
enabling the femtocell to detect the backhaul network being in a disconnection status;
enabling the femtocell to switch to a user equipment (UE) mode after the femtocell detects the disconnection status; and
enabling the femtocell to build a connection with the base station by the UE mode so that the femtocell is able to connect to the Internet via the base station and the femto gateway.

2. The communication method as claimed in claim 1, further comprising the steps of:
enabling the femtocell to send a disconnection notification message to the femto gateway after the femtocell builds the connection with the base station.

3. The communication method as claimed in claim 1, wherein the step of enabling the femtocell to build the connection with the base station by the UE mode comprises the steps of:
enabling the femtocell to receive a synchronization signal from the base station;
enabling the femtocell to receive a piece of basic information from the base station;
enabling the femtocell to proceed a security certification procedure with the femto gateway via the base station; and
enabling the femtocell to build a data stream with the femto gateway via the base station.

4. A computer readable medium, being stored with a computer program for causing a femtocell to execute a communication method when the computer program is loaded into the femtocell, a network system comprising the femtocell, a base station, and a femto gateway, the base station connecting to the Internet via the femto gateway, the femtocell initially connecting to the Internet via a backhaul network, the computer program comprising:
a code A for enabling the femtocell to detect the backhaul network being in a disconnection status;
a code B for enabling the femtocell to switch to a UE mode after the femtocell detects the disconnection status; and
a code C for enabling the femtocell to build a connection with the base station by the UE mode so that the femtocell is able to connect to the Internet via the base station and the femto gateway.

5. The computer readable medium as claimed in claim 4, wherein the computer program further comprises:
a code D for enabling the femtocell to send a disconnection notification message to the femto gateway after the femtocell builds the connection with the base station.

6. The computer readable medium as claimed in claim 4, wherein the code C comprises:
a code C1 for enabling the femtocell to receive a synchronization signal from the base station;
a code C2 for enabling the femtocell to receive a piece of basic information from the base station;
a code C3 for enabling the femtocell to proceed a security certification procedure with the femto gateway via the base station; and
a code C4 for enabling the femtocell to build a data stream with the femto gateway via the base station.

7. A femtocell, a network system comprising the femtocell, a base station, and a femto gateway, the base station connecting to the Internet via the femto gateway, the femtocell initially connecting to the Internet via a backhaul network, the femtocell comprising:
a detection unit, being configured to detect the backhaul network being in a disconnection status;
a switch unit, being configured to switch to a UE mode after the detection unit detects the disconnection status; and
a transceiver, being configured to build a connection with the base station by the UE mode so that the femtocell is able to connect to the Internet via the base station and the femto gateway.

8. The femtocell as claimed in claim 7, wherein the transceiver is further configured to send a disconnection notification message to the femto gateway after the femtocell builds the connection with the base station.

9. The femtocell as claimed in claim 7, wherein the transceiver is further configured to receive a synchronization signal and a piece of basic information from the base station, proceed a security notification procedure with the femto gateway via the base station, and build a data stream with the femto gateway via the base station.
